(19) United States
(12) Patent Application Publication
(10) Pub. No.: US 2009/0121474 A1
(43) Pub. Date: May 14, 2009

(54) Skill based gaming ticket device

(76) Inventor: Michael L. Hughes, Los Angeles, CA (US)

Correspondence Address: MICHAEL HUGHES, 600 S. CURSON AVE, APT. 631, LOS ANGELES, CA, 90036, US

(21) Appl. No.: 11/443,041

(22) Filed: May 31, 2006

Related U.S. Application Data
(63) Continuation of application No. 11/416,538, filed on May 3, 2006.
(60) Provisional application No. 60/676,803, filed on May 3, 2005.

(51) Int. Cl. B42D 15/00; G06Q 90/00

(52) U.S. Cl. 283/100; 705/500

(57) ABSTRACT

A system for providing a higher level of security, entertainment and reliability in distributing treats to children, a method for producing skill based gaming ticket sets including taking sponsorship orders from multiple sponsors who pay promotional consideration for their product's exposure to be included on individual skill based gaming ticket formations contained within a set, and a fundraising method which raises funds through the distribution of sets of skill based gaming tickets. The systems and methods include utilizing a skill based gaming ticket device comprising skill based game indicia, prize indicia, and a plurality of answers or solutions affixed to the surface of the device, a means for dividing up the plurality of answers or solutions into selected areas arranged so that each of the answers or solutions are individually in one given area, a removable coating secured to the surface of the device beneath each of the individual answers or solutions, at least one identification code which distinguishes a winning outcome from a non-winning outcome beneath the removable coating, an outcome reward system wherein a player's skills are tested and the outcome of the game is always under the player's influence, whereby choosing the correct answer or answers by a recipient would result in a prize being awarded; choosing an incorrect answer or answers by a recipient would result in a prize not being awarded; the prize compromises a predetermined redeeming value that is reduced from the cost of a predefined object, and the value is a selected one of a predetermined amount of money, a predetermined percentage of money, and the full price of the predefined object.

### CROSS REFERENCE TO RELATED APPLICATION(S)

This application is a continuation of U.S. non provisional application Ser. No. 11/416,538 filed May, 3, 2006, which claims priority to U.S. provisional application No. 60/676,803 filed May, 3, 2005.

### BACKGROUND OF THE INVENTION

The present invention relates generally to a skill based gaming ticket device and additionally relates to a system for the distribution of treats to children through the use of the skill based gaming ticket device. For the benefit of explanation, one embodiment of this invention would be used in distributing Halloween treats to children in a safe, entertaining and reliable manner, however can also be used in distributing treats to other entities for other holiday and non-holiday purposes as well.

Halloween is a wonderful time of year for most children. They have the opportunity to dress up as their favorite hero or character, and solicit their friends, family, and neighbors for Halloween treats by walking up to their front door and saying Trick or Treat. Today, Americans spend an estimated $6.9 billion annually on Halloween, making it the country's second largest commercial holiday.

As Halloween has quickly become the second most popular retail holiday in the United States (just behind Christmas), the holiday's popularity combined with a tradition that leaves our children vulnerable to receiving edible treats from strangers has inflated long-standing fears about the safety of our children.

An incident that brings life to these fears occurred in Minneapolis in 2000. James Joseph Smith (49) was charged with one count of adulterating a substance with intent to cause death, harm or illness after it was determined he'd put needles in Snickers bars and had been handing them out to children on Halloween. A 14-year-old boy was pricked by a needle hidden in a bar he'd bitten into, but fortunately only required minor medical attention.

It's been a long time since Trick-or-Treating was safe. For years, miscreants have been attempting to harm children with poisoned candy, razor blades, needles and more. Every year, the Poison Control Center receives numerous calls from parents concerned about the safety of candy children receive while trick or treating. Unfortunately, the only advice the Poison Control Center can offer is to suggest that parents, who often aren't aware of what to look for, inspect the treats to the best of their abilities before their children eat them. More recently, this, coupled with the holiday following on the heels of the anniversary of the September 11 attacks on the U.S., has left many parents extra fearful and suspicious of these indistinguishable attacks on their children as a form of terrorism against the United States.

In 2002, a Costco employee reported to the FBI that a gentleman of middle eastern descent opened up an account at the Hackensack, N.J. Costco and purchased close to $7,000 worth of candy. This same person purchased close to $15,000 worth of addition Candy 2 days before at the Wayne, N.J. Costco. The cashier became alarmed at this large purchase of candy and more so when the person paid cash. Around the same time, 2 Arabic men bought more than $35,000.00 dollars worth of candy, in Wayne, N.J. $15,000.00 & in Hackensack, N.J. $20,0000.00. After they left, it was found that their Costco identification was fake, & they also paid for the candy with cash.

Whether these reports are substantiated or are altered versions of urban legends, their lasting effects on parents across the United States are real; most parents don't believe in ghosts and goblins anymore, but they do believe in criminals.

In recent years, shopping malls have become the safe alternative to trick or treating to unknown neighbors with kids going store-to-store for candy from employees. Unfortunately, due to the finite number of stores in a given shopping mall, this process is less exciting and somewhat limiting to children who want to maximize their trick or treating activities. In addition, such a process of having children dress in their favorite costumes to go to a shopping mall compromises the dated tradition of trick or treating.

Currently, there is a need for a device and system that allows children to experience Halloween trick-or-treating in the traditional manner, while providing a higher level of security, entertainment and reliability in the manner they receive Halloween treats.

### BRIEF DESCRIPTION OF THE DRAWINGS

This invention may be embodied in the form illustrated in the accompanying drawings, attention being called to the fact, however, that the drawings are illustrative only, and that changes may be made in the specific construction illustrated.

Various other objects, features and attendant advantages of the present invention will become fully appreciated as the same becomes better understood when considered in conjunction with the accompanying drawings, in which like reference characters designate the same or similar parts throughout the several views, and wherein:

FIG. 1 is a plan front view of a skill based gaming ticket which emphasizes a skill based trivia question, four possible answers printed over a removable coating, and a concealed prize;

FIG. 2 is a plan front view of a skill based gaming ticket which emphasizes a removed coating revealing a winning outcome and a non-concealed prize;

FIG. 3 is a plan front view of a skill based gaming ticket which emphasizes a removed coating revealing a non-winning outcome and a concealed prize;

FIG. 4 is a plan front view of a skill based gaming ticket which emphasizes a removed coating revealing a winning outcome and a points-based reward system;

FIG. 5 is a schematic block diagram of the system of the present invention.

FIG. 6 is a schematic block diagram of a fundraising method for raising funds through marketing the skill based gaming ticket, according to an embodiment of the present invention.

FIG. 7 is a schematic block diagram of an online fundraising method for raising funds through marketing the skill based gaming ticket, according to an embodiment of the present invention.

### DETAILED DESCRIPTION OF THE INVENTION

Turning now descriptively to the drawings, in which similar reference characters denote similar elements throughout several views, the attached figures illustrate various embodiments of a skill based gaming ticket device, the skill based gaming ticket device used in a system for distributing treats to children while providing a higher level of security, entertainment and reliability in the manner that they receive them, and the skill based gaming ticket device used in a method of fundraising, including an online fundraising method.

In this respect, before explaining at least one embodiment of the invention in detail, it is to be understood that the invention is not limited in its application to the details of the arrangements of the components set forth in the following description or illustrated in the drawings. The invention is capable of other embodiments and of being practiced and carried out in various ways. Also, it is to be understood that the phraseology and terminology employed herein are for the purpose of the description and should not be regarded as limiting.

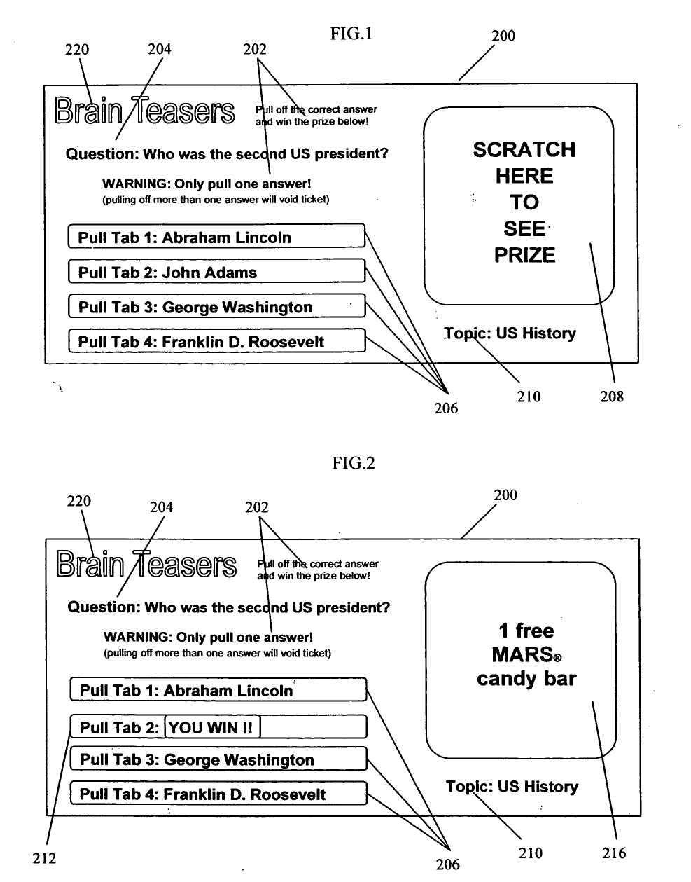

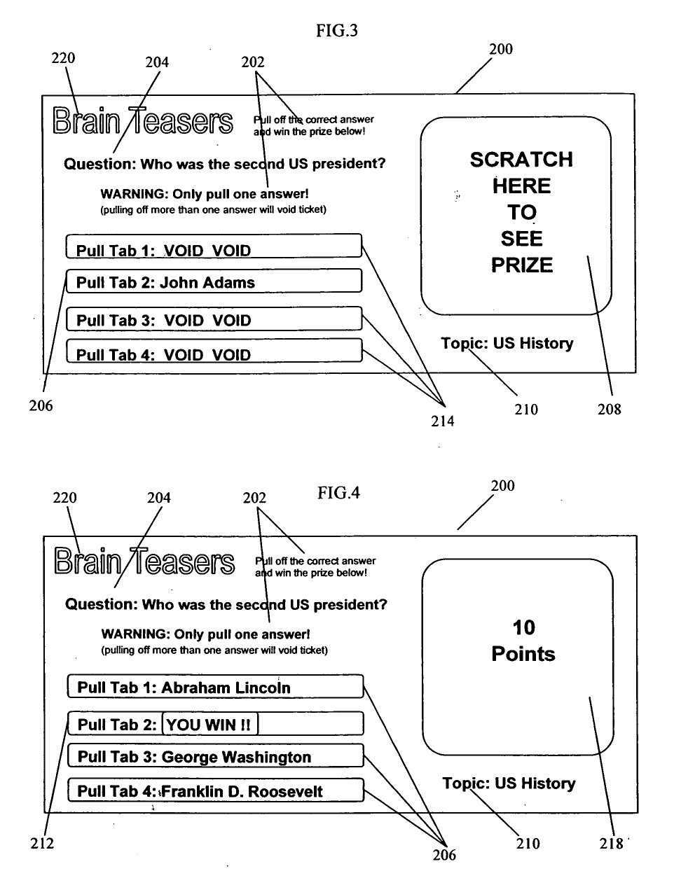

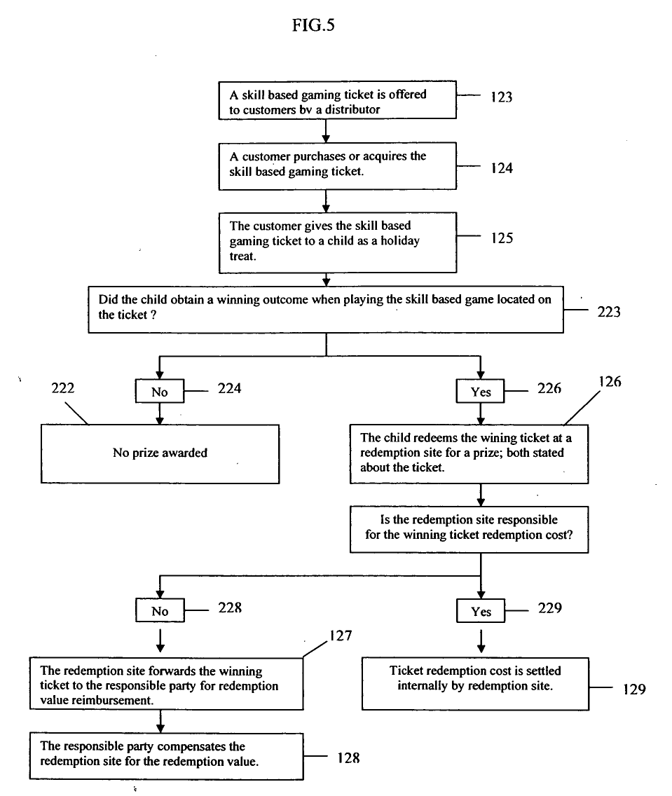

FIGS. 1-4. A skill based gaming ticket 200 is introduced. The skill based gaming ticket 200 is a substrate device comprised of a certificate, ticket, voucher, token, coupon, coin, or computer readable storage medium, entitling a recipient or player bearing a winning outcome 212 on the skill based gaming ticket 200 to receive a prize or award 216. The skill based gaming ticket 200 is manufactured of paper, card or cover stock, plastic, fabric, metal, wood, electronic matter, chemical matter, organic matter, or other similar printable or mark-able material; and is typically rectangular in shape but may take other shapes or forms, such as the shape of a pumpkin or other holiday-related shapes. Size, shape, materials, and construction are not critical to the usefulness of the ticket 200, and are not limiting factors in the definition or usefulness of the ticket 200.

The skill based gaming ticket in one embodiment is a game card device for participating in a game of skill comprising skill based game indicia, prize indicia, and a plurality of answers or solutions affixed to the surface of the device, a means for dividing up the plurality of answers 206 or solutions into selected areas arranged so that each of the answers or solutions are individually in one given area, a removable coating secured to the surface of the device beneath each of the individual answers or solutions, at least one identification code which distinguishes a winning outcome from a non-winning outcome beneath the removable coating, an outcome reward system wherein a player's skills are tested and the outcome of the game is always under the player's influence, whereby choosing the correct answer or answers by a recipient would result in the ticket being redeemable for the prize stated on the ticket; choosing an incorrect answer 214 or answers by a recipient would result in the ticket not being redeemable for the prize stated on the ticket.

In one embodiment, the prize compromises a predetermined redeeming value that is reduced from the cost of a predefined object, and the value is a selected one of a predetermined amount of money, a predetermined percentage of money, and the full price of the predefined object. In one embodiment, multiple winning gaming tickets can be combined and redeemed together against a single higher valued object. In one embodiment, the redeeming value is predetermined, but the redeeming object is not. In one embodiment, the redeeming object is predetermined, but the redeeming value is not.

In one embodiment, the gaming ticket contains removable coating or other methods of concealment, such as scratch-off matter or pull tabs, covering game indicia, game outcome indicia or the prize the winning ticket is valid or redeemable for. In one embodiment, game indicia are affixed over the removable coating. For example, a skill based game and answers are affixed to the surface of the ticket. A removable coating is also secured to the surface of the ticket beneath each of the individual answers, and at least one identification code which distinguishes a winning outcome from a non-winning outcome is affixed beneath the removable coating, whereby a player who removes removable coating the correct answer or answers are affixed to will reveal a winning outcome; a player who removes the removable coating the incorrect answer or answers are affixed to will reveal a non-winning outcome. In one embodiment, game indicia are affixed under the removable coating.

Although the present embodiment of the invention depicts answers printed on a removable coating, and at least one identification code which distinguishes a winning outcome from a non-winning outcome is affixed beneath the removable coating, all arrangements of game, concealment and outcome are considered to be included as embodiments of the present invention.

In one embodiment, the skill-based gaming tickets are designed to encompass at least one of the following guidelines: (1) Participants must have a distinct possibility of exercising skill and must have sufficient data upon which to calculate an informed judgment; (2) Participants must have the opportunity to exercise the skill and the general class of participants must possess the skill; (3) Skill or the competitor's efforts must sufficiently govern the result; (4) The standard of skill must be known to the participants and this standard must govern the result. (5) Questions cannot be too hard or too easy; (6) Judging criteria is objective and is clearly disclosed (7) All entrants are competing on the same or equal playing field.

The skill based gaming ticket 200 may be printed or otherwise marked with instructions 202, prize redemption value 216, prize description, redemption site or location, some additional specific or relative value for which the ticket is valid, name or title of the skill based gaming ticket 220, at least one bar code or other tracking means, ticket category 210 such as a topic or skill level, concealed prize indicia 208, non-concealed prize indicia 216, possible applications, limitations, restrictions, expiration dates and may include security features to thwart off unauthorized duplication.

In one embodiment, the skill based gaming ticket 200 can be used as an entry for the holder to enter into a contest, raffle, or sweepstakes to win a treat or prize. In one embodiment, the skill based gaming ticket contains an identifying code such as a barcode or alpha numeric code, where the identifying code is pre-determined to be the winning code of an award. In one embodiment, the skill based gaming ticket contains an identifying code, where the identifying code is pre-determined to not be the winning code of an award. In one embodiment, the gaming tickets contain educational material or entertainment such as tattoos, scratch and sniff matter and stickers.

In one embodiment, the skill based gaming ticket has a request for personal information about the ticket, such as name, address, date of birth, text messaging information, electronic contact information, email address, etc, so the ticket manufacturer ticket distributor, or ticket sponsor can keep in touch with the ticket recipients for future promotional purposes. In one embodiment, the name and/or logo of a charity, non-profit organization, cause, or school who would receive a portion of the ticket's proceeds would be displayed about the ticket. In one embodiment, the ticket contains trivia 204 or a holiday message.

In one embodiment, characters, logos or artwork familiar to children, such as popular cartoon and movie characters would be placed about the tickets for recognition and promotional purposes, according to the licensing guidelines of each perspective character licensor. In one embodiment, the tickets would contain non-merchandise, promotional material from at least one sponsoring 3^{rd} party, promoting the 3^{rd} party's goods or services, such as a new movie coming to theatres.

In one embodiment, the skill based gaming ticket contains a numeric, alphabetical, or alpha-numeric sequence, which when inserted about an internet portal, cell phone, PDA, or computer program, brings about a form of value. In one embodiment, the value is at least one unit of downloadable or non-downloadable music or video, downloadable telephone ring-tone, non-downloadable online gaming, or similar downloadable or non-downloadable entertainment.

In one embodiment, the value or winning prize is awarded in points 218 or equivalent means, whereby a recipient redeems the points for a value 126. In one embodiment, a combination of at least two of the aforementioned embodiments would provide the recipients with options to choose from. In one embodiment, the redeeming entity can program a website to identify a particular product, service or offer, such as particular post-holiday items remaining in inventory as the redeeming object. In one embodiment, a recipient would provide personal data to redeem the award. In one embodiment, a recipient would not have to provide personal data to redeem the award.

In one embodiment, a recipient can use a code to log onto a website & activate an online skill based game, where they can virtually remove concealing matter with a peripheral device; a winning outcome results in a prize being awarded; the prize being an award that can be printed and redeemed locally or redeemed online. In one embodiment, at least one ticket per person or household would be available at no cost to recipients through mailing in a postcard, logging onto a website, or other non-paying means as an additional method of participating and to comply with state and national sweepstakes laws where applicable.

In one embodiment, the skill-based gaming tickets contain games or educational matter, such as math, history, spelling, science or trivia to add entertainment or educational value. In one embodiment, recipients are interactively tested in trivia. In one embodiment, recipients are interactively tested in online trivia, whereby inserting a code from the ticket into a website activates a trivia game. In one embodiment, a removable coating printed with trivia answers conceals additional codes; removing the coating printed with the proper answer reveals said code which brings about a value, a game of chance, an entertainment value or another skill based game when inserted into a website or phone device. In one embodiment, inserting a code into the website or phone device which was concealed under an incorrect answer ends the trivia game.

In one embodiment, a plurality of skill based gaming tickets are distributed in a set or booklet. In one embodiment, the booklet contains a theme, such as for Halloween, and each ticket within the booklet is designed to encompass the theme. For example, a booklet called “The Great Halloween Scratch-off!” contains 10 skill-based gaming tickets, each having Halloween themes and names as follows; Zombie Scratch, Haunted Giveaway, Black Cat Scratch, Scarecrow Scratch, Pumpkin Patch Freebee Scratch, Jack-O-Scratch, Franken-Scratch, Ghost & Goblin Giveaway, Spider Scratch, Which Witch will Scratch which Scratch. In one embodiment, a combination of skill based game indicia, prize, coupon, promotion or a giveaway would be on the gaming ticket. In one embodiment, if the recipient didn't win the game prize, they would still receive the benefit of the coupon, promotion or giveaway.

The following is several examples of holiday-themed, skill based game indicia which is affixed to the surface of the ticket, in one embodiment. It is appreciated that the characters & brand names are used herein for conceptual purposes only. It is to be understood that the invention is not limited in its application to the details of the arrangements of the gaming components set forth in the following examples, and that the indicia is displayed below without graphics for conceptual purposes only. Also, it is to be understood that the phraseology and terminology employed herein are for the purpose of the description and should not be regarded as limiting.

1. Halloween Word Guess:
Instructions: Scratch the letters that make up the missing word and win the prize. Scratching a wrong letter will reveal a red box, which ends the game and voids the ticket.

The wicked _{— — — — —} of the west.
C K W P T F I M H A

2. Halloween Word Search:
Instructions: Scratch the letters that make up the words below and win the prize. Scratching a wrong letter will reveal a red box, which ends the game and voids the ticket.

| | |
|---|---|
| W I T C H T A C K C A L B M V | HALLOWEEN |
| A D N Q W M Y G E W L C G A N | WITCH |
| N S O A R N C R U E P Y M B C | CREEPY |
| A D N Q W M Y G E W L C G A N | PUMPKIN |
| N E O A R N C R D E L Y M B C | SCARY |

3. Costume Guess:
Instructions: Scratch the correct name of the character below that doesn't belong and win the prize. Scratching a wrong letter will reveal a red box, which ends the game and voids the ticket.
GRAPHICS DISPLAY OF 5 CHARACTERS IN HALLOWEEN COSTUMES; 4 FROM A GROUP AND ONE MISFIT
   Which one doesn't belong?
      A. Snoopy
      B. Linus
      C. Lucy
      D. Charlie Brown
      E. Sponge Bob Square Pants

4. Find the Hidden Ghost: (display of a creepy house & graveyard in front. Several scratch off opportunities across the yard)
Instructions: Scratch the correct location of the ghost below and win the prize.
LOOK AT THE HINT! Scratching a wrong place will reveal a red box, which ends the game and voids the ticket.
HINT: (the hint is a form of trivia that would indicate where the ghost is)

5. What's in the Candy Bag?: (cartoon of Maria holding her candy bag)
Instructions: Scratch the correct answer below and win the prize. Scratching a wrong answer will reveal a red box, which ends the game and voids the ticket.
Maria went trick or treating tonight. At house 1, Maria got 2 blow pops. At house 2, Maria got 6 candy corns. At house 3, Maria got 5 gummy bears. At house 4, Maria got 2 sticks of gum, but ate one after her mother said it was alright. How many pieces of candy are in Maria's bag?
A. 11
B. 14
C. 17
D. 25

6. Trick or Treat?:
Instructions: Help the kids choose the right road to the house and win the prize. Scratching a wrong road will reveal a red box, which ends the game and voids the ticket.
(display of kids in costume on one side of ticket; a house & candy on the other side of ticket, with a maze of 4 different roads. Only one of the roads leads to the house.)
   A. ROAD # 1
   B. ROAD #2
   C. ROAD #3
   D. ROAD #4

7. Candy Corner:
Instructions: Choose which candy is not Halloween candy and win the prize. Scratching a wrong answer will reveal a red box, which ends the game and voids the ticket.
A. Display of candy corn
B. Display of candy pumpkin
C. Display of candy cane
D. Display of some other Halloween candy

8. Who am I?:
Instructions: Choose the correct name of the character below and win the prize. Scratching a wrong answer will reveal a red box, which ends the game and voids the ticket.
   (display of Freddy Kruger grinning with hand of knives in front of him)
A. Jason
B. Freddy Kruger
C. Michael Meyers
D. Al Gore

9. How much of the Pumpkin Pie is left?:
Instructions: Choose the correct percentage of pie remaining and win the prize. Scratching a wrong answer will reveal a red box, which ends the game and voids the ticket.
   (Display of a Pumpkin Pie with 25% Remaining)
A. 3/4
B. 1/4
C. 4/1
D. 2/4

10. Pumpkin Patch Match Game:
Instructions: Scratch only the 4 matching pumpkins that have a matching pair and win the prize. Scratching a wrong pumpkin will reveal a red box, which ends the game and voids the ticket.
   (Display of 12 Pumpkins in a 3×4 Format; 4 Matching Pairs & 4 Misfits)

11. How many Ghosts are in the Graveyard?:
Instructions: Scratch the correct answer and win the prize. Scratching a wrong answer will reveal a red box, which ends the game and voids the ticket.
(display of a graveyard with a plurality of ghosts, some obvious, some a bit hidden)
   A. 6 Ghosts
   B. 8 Ghosts
   C. 10 Ghosts
   D. 12 Ghosts

12. Spelling Brew:
Instructions: Scratch the correctly spelled phrase and win the prize. Scratching a wrong answer will reveal a red box, which ends the game and voids the ticket.
(Display of 2 witches with a witch's brew in the middle, both looking at a watch)
A. Which witch will watch which watch?
B. Witch wich will watch witch watch?
C. Wish Witch will watsh which watch?
D. Which witch will watch witch watch?

In one embodiment, multiple gaming tickets are combined by a player in a single game of skill, such as a treasure or scavenger hunt. In one embodiment, the skill based gaming tickets contain a coupon value to be applied towards the purchase of goods or services. In one embodiment, the skill based gaming tickets are not holiday specific, and are distributed year round, including non-holidays.

The skill based gaming tickets 200 can be distributed in other forms, including but not limited to being coupled together as a set or booklet comprising: a front cover and back cover having a common edge, a number of tickets 200 each coupled to the common edge, at least one bar code or means of identifying the booklet; wherein front and back covers and the tickets 200 are coupled to a common edge such that front cover, back cover, and tickets 200 are open-able and closable in a book-like manner. In one embodiment, the tickets 200 are coupled without a front and back cover and are connected and perforated on the north and south sides or east and west sides of the ticket in a lottery ticket fashion. In one embodiment, tickets are sold individually.

It is also within the present invention to color-code, or differentiate the booklets or sets. For example, booklets containing different numbers of tickets, different features, or with tickets 200 of different themes may be color coded with different colored prominent headings or borders, or otherwise differentiated. In one embodiment, the individual tickets or ticket sets are differentiated by the skill level of the game indicia affixed to the surface of the ticket. It is appreciated that color-coding or other methods of differentiation advantageously assists the distributor and consumer to quickly differentiate between the booklet, set or individual ticket differences.

In one embodiment, several high-valued prize giveaways are offered as the prize on the skill based gaming tickets and are concealed within booklets or sets along with gaming tickets containing standard product giveaways mentioned above to generate a higher demand and perceived value of the gaming tickets and sets in the target market.

In one embodiment, the tickets and ticket sets are designed in other languages to cater to specialty or minority markets, or are themed towards boys, girls, age groups, or special interest groups. In one embodiment, the prizes offered on the tickets are coordinated with the theme of the booklet or ticket. In one embodiment, the skill-based gaming indicia located on the tickets is coordinated with the theme of the booklet or ticket. In one embodiment, the ticket formations include a sponsor's product as game indicia in a game of skill.

In one embodiment, the booklets also contain coupons or promotional materials targeted towards the entities, such as mothers or wives, who purchase or acquire the booklets of tickets to distribute. In one embodiment, consideration is paid by a sponsoring company for including the coupons or promotional materials in the booklets or sets, which helps to defray costs associated with the manufacturing, promotion, distribution or redemption of the ticket sets.

In the context of this skill based gaming ticket description, the terms “ticket” and “skill-based gaming ticket”, “prize” and “award”, “booklets” and “ticket sets”, and “ticket” and “certificate” are intended to be general and all-inclusive within the parameters stated above and defining its purpose and use.

FIG. 5. One embodiment of the present invention provides an improved system for distributing Halloween treats to children that allows children to experience Halloween trick-or-treating in the traditional manner, while providing a higher level of security, entertainment and reliability in the manner that they receive the Halloween treats, where sets of the skill based gaming tickets 200 are distributed 123 through at least one product manufacturer, retail store, grocery store, gas station, mass merchant, membership store, food establishment, convenience store, 3^{rd} party distributor, downloadable or non-downloadable entertainment company, school, student, charitable or non-profit entity, religious organization, 501(c) corporation, and the likes thereof; and are purchased 124, given along with a purchase, given for free, or otherwise acquired by customers for the purpose of giving them as a gift of a Halloween treat to children during the Halloween holiday.

In one embodiment, sets of the skill based gaming tickets 200 are purchased 124 or acquired through a website, internet portal, internet company, vending machine, or other electronic or non-personal source, and are delivered directly, through mail, downloaded or received electronically by customers to print or otherwise distribute as previously described.

After a customer purchases 124 or acquires the set of skill based gaming tickets 200, they give 125 at least one of the tickets 200 to children as a Halloween treat while trick-or-treating, holiday parties at their school, or through other holiday or non-holiday gift-giving situations. In one embodiment, the prize value is concealed 208, where the recipient first removes the concealment to identify the prize or redeeming value. In one embodiment, the prize value is not concealed 216. In one embodiment, the prize is points 218 or other means of indirect or generic value redeemable for a direct or specific value.

If the child plays the skill based game on the ticket 223 & the game results in a non-winning outcome 224, then no prize is awarded 224. If the child plays the skill based game on the ticket 223 & the game results in a winning outcome 226, typically within a certain time period after the holiday has passed, and before an expiration date such as 30, 60, or 90 days, a child takes the ticket 200 with the winning outcome 212 to the redemption location as specified on the skill based gaming ticket 200, such as the local treat distributor, retail store, grocery store, gas station, mass merchant, treat manufacturer, convenience store, website or a combination thereof, and redeems 126 the winning ticket 212 for the prize 216 specified about the ticket 200; to receive the prize value directly from such location. In one embodiment, the winning ticket recipients would redeem 126 the ticket 200 directly through the mail, through the internet, or through other non-personal means.

After the redemption 126 of the ticket 200, if the origin, sponsoring entity or financially responsible party of the ticket redemption cost was an entity other than the entity who redeemed the winning ticket 228, such as the ticket or prize manufacturer, then the entity who redeemed the ticket may deliver 127 the redeemed ticket to their redemption agent, redemption facility, or clearinghouse; where valid winning tickets are delivered to the financially responsible party, who compensates 128 the entity who redeemed the ticket 200 for the redeeming value. Alternatively, if the origin or financially responsible party of the ticket 200 was the entity who redeemed the winning ticket 229, the ticket 200 is settled 129 internally by the entity that redeemed the winning ticket 200.

In one embodiment, the redeemable skill based gaming ticket is distributed by a product manufacturer, distributor or 3^{rd} party at no charge to consumers, whereby the ticket manufacturing cost and recipient redemption cost is absorbed by a sponsor or multiple sponsors, such as a product manufacturer as a promotional tool. For example, a downloadable entertainment company may sponsor ticket sets of holiday tickets, to be given out at Halloween or a non-holiday at no cost, which allow it's recipients to download or participate in at least one free unit of entertainment from the company's website, and the cost of the download is incurred by the entertainment company as a means to generate awareness and new customers to their goods, services or website.

In one embodiment, the booklets are comprised of a plurality of individual gaming ticket formations, with one or multiple sponsors' products as the prize, game indicia or predetermined objects on a plurality of the tickets as a way to promote products of participating sponsors who pay consideration for product exposure. In one embodiment, the sponsor or sponsors pay a sponsorship fee based on booklet distribution numbers, a flat promotional fee (for example, $100,000 per ticket in a booklet), a revenue share of consideration generated from the distribution of the gaming tickets, a percentage or the whole redemption cost of the winning gaming tickets, or a combination thereof as consideration for their product exposure. In one embodiment, a percentage of the consideration paid by a sponsor is held in escrow to be applied against the cost of the prize redemption expense until after the redemption period has passed. In one embodiment, the sponsor does not pay a sponsorship fee.

In one embodiment, promotional gaming ticket sets are manufactured by taking sponsorship orders from multiple sponsors who pay consideration for their product's exposure to be included on individual gaming ticket formations contained within a set, with multiple sponsors' products as the prize item, featured object, game indicia or predetermined object on individual tickets which vary from ticket to ticket with different products from different sponsors, so as to provide products from a plurality of different sponsors at frequencies that vary between sponsors.

In one embodiment, the skill based gaming tickets are manufactured or distributed by a 3^{rd} party to customers for a fee whereby the 3^{rd} party retains the fee for promotional or distribution efforts, but the ticket redemption cost is absorbed by the sponsor whose offer is located about the ticket as the promotional cost for a means to generate awareness and new customers to their goods, services or website.

In one embodiment, the revenue generated by the distribution of the skill based gaming tickets is shared with a distributor, a redeeming prize sponsor, a redeeming entity, a nonprofit entity, or the ticket manufacturer. In one embodiment, both the consideration generated from the distribution of the skill based gaming tickets and the expense incurred in the redemption of the winning skill based gaming tickets are shared with a distributor, a redeeming prize sponsor, a redeeming entity, a nonprofit entity, or the skill based gaming ticket manufacturer.

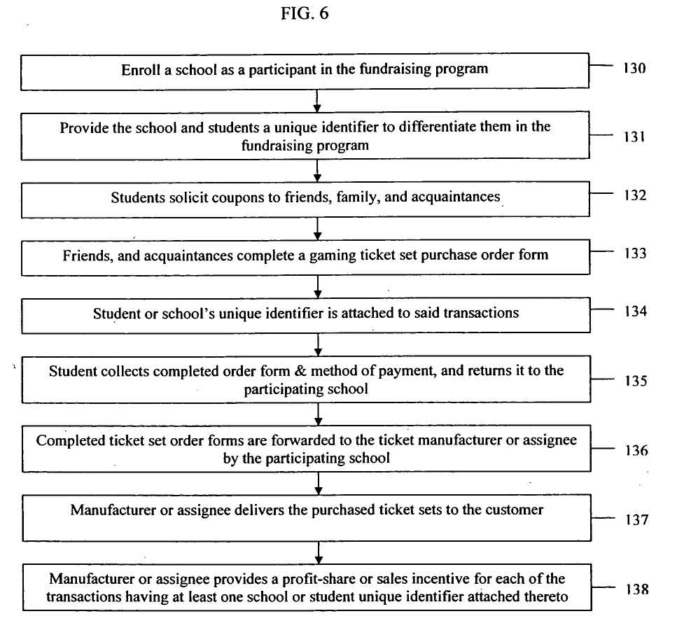

FIG. 6. One embodiment of the present invention is a method for participating schools, non-profit organizations, and the likes thereof to distribute the skill based gaming tickets as a fundraising tool, consisting of (a) enrolling 130 at least one school as a participant in a charitable program (b) providing 131 the participant schools and students a unique identifier to differentiate each school and student participating in the fundraising program (c) attaching 134 at least one unique identifier to transactions occurring through participating students and schools (d) providing 138 a profit-share or sales incentive for each of the transactions having at least one school or student designator attached thereto.

Once participating schools are enrolled in the fundraising program 130, students of participating schools, or the likes thereof, solicit 132 the skill based gaming ticket booklets to their family, friends, and acquaintances. Family, friends, and acquaintances complete 133 a gaming ticket set order form, and the student collects 135 a completed sales order form and a method of payment, and return them to their school, attaching 134 at least one student unique identifier to each transaction. The participating school then forwards 136 the order form to the ticket manufacturer or responsible company, who delivers 137 the skill based gaming ticket booklet directly to the customer, and provides 138 a sales incentive or share of the revenues from the associated transactions to the participating schools.

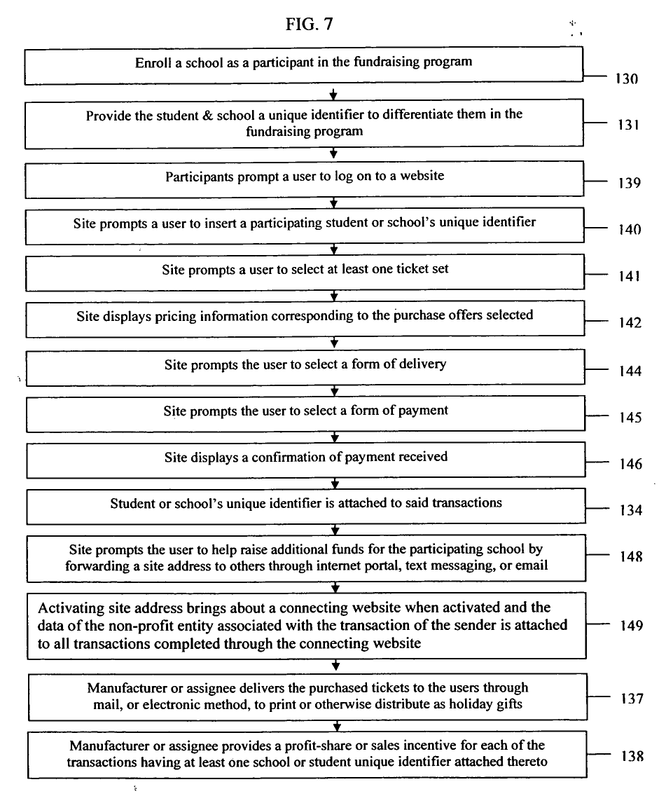

FIG. 7. In one embodiment, students and participating schools are provided 131 with a unique identifier, such as an identification number. Students promote the fundraising program through prompting 139 family, friends, acquaintances, and potential supporters to log onto a participating website or internet portal. The website prompts 140 a user to input the student's and/or school's unique identifier.

In one embodiment, the website or internet portal contains a unique identifier search for when the user has the name of the student, but doesn't have the unique identifier. In one embodiment, when the user enters the student's unique identifier, a webpage appears with the student's name and the name of the associated school. In one embodiment, the page displays the amount of sold gaming ticket sets credited to the particular student, the highest number of sold gaming ticket sets credited to a single student, or top 10 students, in the particular student's school or area, or the total number of sold gaming ticket sets credited to the particular student's school.

A user is prompted 141 to select at least one skill based gaming ticket booklet. In one embodiment, the site offers the user a variety of booklets to choose from, each containing various gaming ticket offers, various amounts of tickets, various skill levels or other forms of differentiation. The site displays 142 associated pricing information corresponding to the ticket set order. Once the user indicates their intent to complete the transaction and checkout, the site in one embodiment displays a preview of the order and associated cost is shown. In one embodiment, the site prompts 144 the user to select a form of delivery and costs associated with expedited shipping. The site prompts 145 the user to select a form of payment, and once received and confirmed, the site displays 146 a confirmation of payment page, and in one embodiment, a receipt is sent to the user via email or other electronic means. The selected gaming ticket sets are then delivered 137 to the user by the ticket manufacturer or pre-determined responsible party, and the manufacturer or assignee provides 138 a sales incentive or share of the revenues from the associated transactions to the participating schools.

In one embodiment, users are prompted 148 to help raise additional funds for the participating cause, non-profit, charity or school by sending an electronic communication containing a website address to family, friends, acquaintances, and potential supporters through an internet portal, email, text messaging, podcast or other electronic means. The website address is connected to a server, and activating 149 the website address brings about an internet website containing identifying data of the non-profit entity selected by the sender; a transaction on the internet website by the recipient generates a revenue-share for the associated non-profit entity.

After confirming the transactions, the manufacturer, sponsor or assignee provides 138 a profit-share or sales incentive for each of the transactions having at least one school or student identifier attached hereto. In one embodiment, manufacturer, sponsor or assignee delivers a prize to the participating schools and students based on their performance levels.

In one embodiment, both the students and schools can access a database where an accounting of their credited transactions are viewable through inputting their unique identifiers and passwords. In one embodiment, customer's data is saved in a database and customer's are added to a mailing list to receive new offers periodically. Customers who purchase future offerings, will have the option to continue to be associated with the school and student that benefited from their initial purchase, where the associated school continues to receive a sales incentive or profit-share.

It should be understood that, while the invention is described herein in terms of skill based gaming tickets distributed on the Halloween holiday, the invention is applicable to other types of goods or services sold at other facilities, including but not limited to software, downloadable and non-downloadable entertainment, balloons, candy, chocolate, gum, holiday games, movie rentals, food, and drink, all children's, teenager, senior citizen and adult products and services; and can be used on all holidays, anniversaries, and birthdays; and all gift giving situations to recipients of all ages, including teenagers, adults and senior citizens, and that tickets may be purchased for individual use and tickets may be replaced by tokens, certificates, coins, gift cards, vouchers, computer readable storage devices, compact discs, electronic mailings, printouts and the like.

Therefore, the foregoing is considered as illustrative only of the principles of the invention. Further, since numerous modifications and changes will readily occur to those skilled in the art, it is not desired to limit the invention to the exact operation shown and described, and accordingly, all suitable modifications and equivalents may be resorted to, falling within the scope of the invention. It will be appreciated that not every implementation will necessarily embody all or even most of the specific embodiments, details and extensions discussed above in relation to the basic system. However, the system is described in the above manner to reduce the need for external reference when

What is claimed is:

1. (canceled)

2. (canceled)

3. (canceled)

4. (canceled)

5. (canceled)

6. (canceled)

7. A promotional gaming ticket having a guaranteed possible win outcome comprising;
a substrate device,
a plurality of play indicia affixed to the surface of the device,
at least one identification code which distinguishes a winning outcome from a non-winning outcome,
an outcome reward system wherein,
a winning outcome is always possible and a promotional prize is always awarded for a winning game outcome,
the promotional prize compromising:
a predetermined redeeming value that is reduced from the cost of a promotional object; where the value is a selected one of a predetermined amount of money, a predetermined percentage of money, and the full price of the promotional object, a removable coating secured to the surface of the device over a selected one of the play indicia, redeeming value and the promotional object indicia.

8. The promotional gaming ticket of claim 7, wherein multiple tickets can be combined and redeemed together against a single, higher valued promotional object.

9. The promotional gaming ticket of claim 7, comprising;
a plurality of individual gaming ticket formations in a set providing promotional products as the promotional objects on a plurality of the tickets to promote products of participating sponsors who pay promotional consideration for product exposure, wherein;
the promotional objects on the tickets contained in the set being different from other promotional objects on the tickets of the same set so as to provide promotional products for a plurality of different participating sponsors which may vary between ticket formations of the set:

10. A method for producing promotional gaming ticket sets comprising:
(a) taking sponsorship orders from multiple sponsors who pay promotional consideration for their product's exposure to be included on individual promotional gaming ticket formations contained within a set, wherein each set includes a plurality of gaming device tickets having a guaranteed possible win outcome, each ticket comprising;
a substrate device, a plurality of play indicia affixed to the surface of the device, at least one identification code which distinguishes a winning outcome from a non-winning outcome, an outcome reward system wherein a winning outcome is always possible and a promotional prize is always awarded for a winning game outcome, the promotional prize compromising: a predetermined redeeming value that is reduced from the cost of a promotional object; where the value is a selected one of a predetermined amount of money, a predetermined percentage of money, and the full price of the promotional object, and a removable coating secured to the surface of the device over a selected one of the play indicia, redeeming value and the promotional object indicia.
(b) producing the set containing a plurality of individual gaming ticket formations with multiple sponsors promotional products as the promotional object on individual tickets which vary from ticket to ticket with different promotional products from different sponsors, so as to provide promotional products from a plurality of different sponsors at frequencies that vary between sponsors.

11. The method of claim 10 wherein a sponsor's promotional consideration paid for exposure received in the promotional gaming ticket sets consists of a selected one of a percentage of the cost of the predetermined redeeming value, a promotional fee, a sponsorship fee, and a share of revenue generated from the distribution of the promotional gaming ticket sets.

12. The method of claim 1 wherein a percentage of the sponsor's promotional consideration is held in escrow to be applied against a percentage of the cost of the predetermined redeeming value, the remaining balance is released to a selected one of the ticket set distributor, a ticket redeeming entity, a non-profit entity, and the ticket manufacturer after a period of time.

13. The method of claim 10 wherein a selected one of the revenue generated from the distribution of the promotional gaming ticket sets and the cost of the predetermined redeeming values of the promotional gaming ticket sets are shared with a selected one of the ticket set distributor, a ticket redeeming entity, a sponsor of the promotional object, a non-profit entity, and the ticket manufacturer.

14. A system for distributing items to children in a secure and reliable manner, comprising:
(a) distributing a plurality of ticket formations by a distributor, the individual ticket formations providing a selected one of a guaranteed redemption value and a game where a winning outcome is always possible and a promotional prize is always awarded for a winning game outcome, comprising: a removable coating secured to the surface of the ticket formation and at least one value part which indicates a redemption value associated with the ticket formation; the redemption value compromising:
a predetermined value that is reduced from the cost of a promotional object;
where the value is a selected one of a predetermined amount of money, a predetermined percentage of money, and the full price of the promotional object;
(b) acquiring the ticket formation by an entity through a selected one of purchasing the ticket formation, receiving the ticket formation along with a purchase, receiving the ticket formation for free;
(c) giving the ticket formation by the entity to a child recipient as a gift;
(d) removing the removable coating by the child recipient to win a game and reveal a selected one of the redemption value and the promotional object indicia;
(e) redeeming the ticket formation by the child recipient for the redemption value associated with the ticket formation.

15. The individual ticket formation of claim 14, wherein a plurality of ticket formations can be combined and redeemed together against a single, higher valued object.

16. The system of claim 14 wherein the distributor is a selected one of a retail store, grocery store, outlet store, wholesale store, drug store, mass merchant, membership store, vending machine, product manufacturer, student, charity, school fundraiser, 501(c) corporation, non-profit entity, religious organization, and internet website.

17. The system of claim 14 wherein the individual ticket formation is manufactured of a selected one of paper, plastic, cotton, mark-able material, synthetic material, fabric, chemical, coin, compact disc and computer readable storage medium.

18. The system of claim 14 wherein the individual ticket formation is a substrate device containing a selected one of a plurality of play indicia affixed to the surface of the device, at least one identification code which distinguishes a winning outcome from a non-winning outcome of the play indicia, a promotional prize indicia, redemption instructions, barcode, alpha-numeric code, expiration date, request for personal information, security feature, redemption value, predetermined object description, removable coating, artwork, trivia, tattoo, sticker, symbols, computer readable entertainment, non-computer readable entertainment, educational material, logo, entry, and holiday message.

19. The system of claim 14 wherein the individual ticket formation is redeemed at a selected one of retail store, grocery store, outlet store, sponsor's business, wholesale store, drug store, mass merchant, membership store, product manufacturer, food establishment, entertainment establishment internet portal and internet website.

20. The system of claim 14 wherein a plurality of ticket formations are purchased in a set through an internet website, a user is prompted to select a non-profit entity from a database, the non-profit entity associated to the selection will participate in a revenue share of the transaction; the non-profit entity is a selected one of a school, organization, foundation, non-profit entity, religious group, trust, student unique identifier, and 501(c) corporation.

21. The system of claim 20 wherein the user is prompted to send an electronic communication through a server to others containing a website address, activating the website address brings about an internet website containing identifying data of the non-profit entity selected by the sender, a transaction on the internet website by a recipient generates a revenue-share for the associated non-profit entity.

22. The system of claim 20 wherein a non-profit entity can track revenue-share activity on an internet website through the use of a predetermined unique identifier and password.

23. A system to liquidate post-holiday inventory at pre-holiday prices, comprising;
(a) distributing a plurality of ticket formations preceding a holiday for a fee by a distributor, the individual ticket formations providing a selected one of a guaranteed possible redemption value and a game where a winning outcome is always possible and a promotional prize is always awarded for a winning game outcome, comprising: a removable coating secured to the surface of the ticket formation and at least one value part which indicates a redemption value associated with the ticket formation; the redemption value compromising: a predetermined value that is reduced from the cost of a promotional object; where the value is a selected one of a predetermined amount of money, a predetermined percentage of money, and the full price of the promotional object, the post-holiday inventory is the promotional object;
(b) purchasing the ticket formation by an entity preceding a holiday;
(c) giving the ticket formation by the entity to a recipient as a gift;
(d) removing the removable coating by the recipient to reveal a selected one of a game outcome, the redemption value and the promotional object indicia;
(e) redeeming the ticket formation by the recipient for the redemption value associated with the ticket formation at the distributor's place of business, the ticket formation is not redeemable until at least the day following the holiday.

24. The individual ticket formation of claim 23, wherein a plurality of ticket formations can be combined and redeemed together against a single, higher valued object.

25. The system of claim 23 wherein the ticket formation contains a computer readable storage medium, the recipient brings the ticket formation to the distributor's place of business to insert through a reading device which identifies the promotional object and redeeming value.

26. The system of claim 23 wherein the distributor can program the reading device to reveal a particular product as the promotional object.

27. A game card device, for participating in a game of skill comprising:
a substrate device,
skill based indicia, prize indicia, and a plurality of answers affixed to the surface of the device, comprising:
a means for dividing up the plurality of answers into selected areas arranged so that each of the answers are individually in one given area,
a removable coating secured to the surface of the device beneath each of the individual answers,
at least one identification code which distinguishes a winning outcome from a non-winning outcome beneath the removable coating,
an outcome reward system wherein,
the outcome of the game is always under the player's influence,
a winning outcome results in a prize being awarded,
the prize compromising:
a predetermined redeeming value that is reduced from the cost of a predefined object;
where the value is a selected one of a predetermined amount of money, a predetermined percentage of money, and the full price of the predefined object.

28. The game card device of claim 27, wherein multiple game card devices can be combined and redeemed together against a single, higher valued object.

29. The game card device of claim 27, comprising;
a plurality of game card devices in a set providing promotional products as a selected one of game indicia and the predefined object on a plurality of the game card devices to promote products of participating sponsors who pay promotional consideration for product exposure, wherein the promotional objects on the game card devices contained in the set being different from other promotional objects on the game card devices of the same set so as to provide promotional products for a plurality of different participating sponsors which may vary between game card formations of the set.

30. A method for producing game card formation sets comprising:
(a) taking sponsorship orders from multiple sponsors who pay promotional consideration for their product's exposure to be included on individual game card formations contained within a set, wherein each set includes a plurality of game card formations, each game card formation comprising; a substrate device, skill based indicia, prize indicia, and a plurality of answers affixed to the surface of the device, comprising: a means for dividing up the plurality of answers into selected areas arranged so that each of the answers are individually in one given area, a removable coating secured to the surface of the device beneath each of the individual answers, at least one identification code which distinguishes a winning outcome from a non-winning outcome beneath the removable coating, an outcome reward system wherein the outcome of the game is always under the player's influence, a winning outcome results in a prize being awarded, the prize compromising: a predetermined redeeming value that is reduced from the cost of a predefined object; where the value is a selected one of a predetermined amount of money, a predetermined percentage of money, and the full price of the predefined object.
(b) producing the set containing a plurality of individual game card formations with multiple sponsors' promotional products as a selected one of game indicia and the predefined object on individual game card formations which vary from ticket to ticket with different promotional products from different sponsors, so as to provide promotional products from a plurality of different sponsors at frequencies that vary between sponsors.

31. The method of claim 30 wherein a sponsor's promotional consideration paid for exposure received on the game card formation sets consists of a selected one of a percentage of the cost of the predetermined redeeming value, a promotional fee, a sponsorship fee, and a share of revenue generated from the distribution of the game card formation sets.

32. The method of claim 31 wherein a percentage of the sponsor's promotional consideration is held in escrow to be applied against a percentage of the game card redemption cost, the remaining balance is released to a selected one of the game card formation set distributor, a game card formation redeeming entity, a non-profit entity, and the game card formation set manufacturer after a period of time.

33. The method of claim 30 wherein a selected one of the revenue generated from the distribution of the game card formation sets and the redemption cost of the game card formations are shared with a selected one of a game card set distributor, a game card formation redeeming entity, a sponsor of the predefined object, a manufacturer of the predefined object, a non-profit entity, and the game card set manufacturer.

34. A system for distributing items to children in a secure and reliable manner, comprising:
(a) distributing a plurality of game card formations by a distributor, the individual game card formations comprising: a substrate device, skill based indicia, prize indicia, and a plurality of answers affixed to the surface of the formation, comprising: a means for dividing up the plurality of answers into selected areas arranged so that each of the answers are individually in one given area, a removable coating secured to the surface of the device beneath each of the individual answers, at least one identification code which distinguishes a winning outcome from a non-winning outcome beneath the removable coating, an outcome reward system wherein the outcome of the game is always under the player's influence, a winning outcome results in a prize being awarded, the prize compromising: a predetermined redeeming value that is reduced from the cost of a predefined object; where the value is a selected one of a predetermined amount of money, a predetermined percentage of money, and the full price of the predefined object.
(b) acquiring the game card formation by an entity through a selected one of purchasing the game card formation, receiving the game card formation along with a purchase, and receiving the game card formation for free;
(c) giving the game card formation by the entity to a recipient as a gift;
(d) removing the removable coating under an answer pattern by the recipient to reveal a selected one of a winning and a non-winning outcome;
(e) redeeming the winning outcome game card formation by the recipient for the redemption value stated on the game card formation.

35. The system of claim 34, wherein a plurality of game card formations can be combined and redeemed together against a single, higher valued object.

36. The system of claim 34 wherein the distributor is a selected one of a retail store, grocery store, outlet store, wholesale store, drug store, convenience store, gas station mass merchant, membership store, vending machine, product manufacturer, student, charity, school fundraiser, 501(c) corporation, non-profit entity, religious organization, and internet website.

37. The system of claim 34 wherein the individual game card formation is manufactured of a selected one of paper, plastic, cotton, mark-able material, synthetic material, fabric, chemical, coin, compact disc and computer readable storage medium.

38. The system of claim 34 wherein the individual game card formation is a substrate device containing a selected one of a plurality of play indicia affixed to the surface of the device, at least one identification code which distinguishes a winning outcome from a non-winning outcome of the play indicia, a prize indicia, redemption instructions, barcode, alpha-numeric code, expiration date, request for personal information, security feature, redemption value, removable coating, artwork, trivia, tattoo, sticker, symbols, computer readable entertainment, non-computer readable entertainment, educational material, logo, entry, and holiday message.

39. The system of claim 34 wherein the individual game card formation is redeemed at a selected one of retail store, grocery store, outlet store, sponsor's business, wholesale store, drug store, mass merchant, membership store, product manufacturer, convenience store, gas station, food establishment, entertainment establishment internet portal and internet website.

40. The system of claim 34 wherein a plurality of game card formations are purchased in a set through an internet website, a user is prompted to select a non-profit entity from a database, the non-profit entity associated to the selection will participate in a revenue share of the transaction and the non-profit entity is a selected one of a school, organization, foundation, non-profit entity, religious group, trust, student unique identifier, and 501(c) corporation.

41. The system of claim 40 wherein the user is prompted to send an electronic communication through a server to others containing a website address, activating the website address brings about an internet website containing identifying data of the non-profit entity selected by the sender, a transaction on the internet website by a recipient generates a revenue-share for the associated non-profit entity.

42. The system of claim 40 wherein a non-profit entity can track revenue-share activity on an internet website through the use of a predetermined unique identifier and password.
